(19) United States
(12) Patent Application Publication
(10) Pub. No.: US 2025/0187233 A1
(43) Pub. Date: Jun. 12, 2025

(54) DEEP-DRAWABLE SEPARATING FILM FOR FIBRE COMPOSITE PLASTIC COMPONENTS

(71) Applicant: Loparex Germany GmbH & Co. KG, Forchheim (DE)

(72) Inventors: Christian HERMANN, Eggolsheim (DE); Peter KUNZELMANN, Röttenback (DE); Matthias MAUSER, Hausen (DE)

(21) Appl. No.: 18/844,414

(22) PCT Filed: Mar. 7, 2023
(86) PCT No.: PCT/EP2023/055665

§ 371 Date: Sep. 6, 2024

(30) Foreign Application Priority Data
Mar. 10, 2022 (DE) 10 2022 105 691.0

(51) Int. Cl. B29C 33/68; B32B 27/08; B32B 27/32

(52) U.S. Cl. CPC B29C 33/68; B32B 27/08; B32B 27/32; B32B 2250/02; B32B 2250/242; B32B 2270/00; B32B 2274/00; B32B 2307/308; B32B 2307/7376

(57) ABSTRACT

The invention relates to a multi-layer separating film, which comprises a first surface layer based on a mixture of a thermoplastic elastomer and a polyolefin, a second surface layer based on at least one polypropylene or propylene copolymer, and an adhesion promoting layer, wherein the separating film has a total layer thickness in the range of 10 to 250 μm. The separating film according to the invention is suitable for producing fiber composite plastic components, in particular by means of a vacuum infusion process.

The priority of the German patent application No. 10 2022 105 691.0 dated Mar. 10, 2022 is claimed.

The invention relates to a multilayer separating film comprising a first surface layer based on a mixture of a thermoplastic elastomer and a polyolefin, a second surface layer based on at least one polypropylene or propylene copolymer, and an adhesion promoting layer, wherein the separating film has a total layer thickness in the range of 10 to 250 μm. The separating film according to the invention is suitable for producing fiber composite plastic components, in particular by means of a vacuum infusion process.

With the aid of separating films or vacuum bags produced therefrom, even fiber composite plastic components of complicated design can be produced for a wide variety of applications, such as for the aviation, aerospace, automotive or wind energy industries. Curable fiber composite plastic semi-finished products, e.g. laminates made of carbon or glass fibers, which are impregnated with a plastic resin to be cured, are placed in a vacuum bag. In principle, the vacuum bag can be formed from a single separating film that completely surrounds the curable fiber composite plastic semi-finished product. In practice, however, the vacuum bag often comprises several elements which are joined together in a vacuum-tight manner.

In some technologies, the semi-finished products are already pre-impregnated with plastic resin (e.g. pre-impregnated fibers (prepregs), pre-impregnated metal grids, etc.), while other technologies are based on non-pre-impregnated semi-finished products which are then impregnated with plastic resin inside the vacuum bag (e.g. in the infusion method).

The curable semi-finished product is then pressed by evacuation into the shaping vacuum-tight tool and sufficiently compacted therein so that gas or air inclusions can escape and the laminate has as few cavities as possible. The overall device consisting of vacuum bag, shaping tool and formed, curable fiber composite plastic semi-finished product, which can be evacuated, is then heated in an autoclave under pressure and heat until the plastic resin has been heated to the curing temperature of the plastic resin. After cooling, the cured fiber composite plastic component can then be removed from the vacuum bag and separated from the vacuum-tight shaping tool.

Fiber composite plastic components are often manufactured in molds using separating means in order to prevent the curable plastic resins used from adhering to the molds. The use of such separating means is time-consuming and cost-intensive, particularly in the production of large-area fiber composite plastic components such as the blades of wind turbines.

In most cases, the production of blades for wind turbines is carried out using a vacuum infusion process in molds, each of which forms half of a blade. The molds are coated with a liquid separating agent in order to achieve a separating effect between the cured plastic resin of the fiber composite plastic component and the mold after the curing of the curable plastic resins introduced in liquid form, usually epoxy or, in rarer cases, polyester resin systems.

The use of these separating agents has many disadvantages. For example, there is a risk of damage to the mold due to insufficient coverage with separating agent. In addition, the surface of the fiber composite plastic component must be elaborately reworked before it can be coated with paint and varnish to achieve a sufficient surface quality. In particular, any unevenness must be sealed with filling agents (so-called pore fillers) and then the correspondingly processed surface of the fiber composite plastic component must be sanded down. This surface treatment is very time-consuming and cost-intensive. The resulting fine dust and the separating agents used as such also pose a health risk to operators.

WO 2014 124945 A1 relates to a siliconized separating film for the production of molded plastic parts from fiber composites using a mold comprising a carrier film which can be deep drawn under vacuum at room temperature and a coating which can be applied in liquid form and which, optionally after the removal of any solvents, consists of more than 90 atomic % silicon, carbon and/or oxygen, more than 45 atomic % carbon, and more than 20 atomic % silicon, in each case based on the entire coating and measured by XPS, characterized in that the coating is crosslinked by addition reactions, condensation reactions or by radiation.

US 2017 0066218 A1 and US 2019 0322075 A1 relate to multilayer separating films having a first outer layer comprising polymethylpentene or a fluorinated polymer and having a first adhesion affinity, and a second outer layer comprising polymethylpentene or a fluorinated polymer and an adhesion adjusting additive. The second outer layer has a second adhesion affinity that differs from the first adhesion affinity of the first outer layer. The difference in adhesion affinity between the first and second outer layer of the separating film enables the film to develop complete separating properties from a mold.

EP 0 364 956 discloses a laminate comprising (A) a layer of a 4-methyl-1-pentene polymer, (B) a layer of a polymer composition comprising (a) 40 to 49% by weight of a random ethylene/α-olefin copolymer containing 30 to 95 mol % of ethylene units, (b) 0.1 to 20% by weight of a polyolefin modified with an unsaturated carboxylic acid or its derivative, and (d) from 1 to 50% by weight of a tackifier, the proportions of components (a), (b) and (d) being based on the total weight of components (a), (b) and (d), and (d) a layer of a thermoplastic resin, wherein layers (A), (B) and (d) are laminated in the order indicated.

EP 0 376 681 discloses a separating film composed of a laminate comprising: (a) an intermediate layer comprising at least one layer of a flexible polyolefin, and (b) two outer layers of crystalline polymethylpentene, one on each side of the intermediate layer.

U.S. Pat. No. 5,123,985 relates to vacuum bags made of thermoplastic elastomer films that readily conform to the surface contour of a workpiece at low pressures without interruption. The thermoplastic elastomer film can be processed into thin films that can withstand high pressures and temperatures.

WO 00/59720 discloses multilayer polymethylpentene-containing separating films, methods of making them and their use in the manufacture of articles comprising cured fiber composite epoxy, phenolic or polyacrylate compositions that can be used as structural elements for aerospace applications. The films have improved separating properties when exposed to high temperatures. The films are non-oriented and multilayered and comprise a polyamide layer, a polymethylpentene layer and an intermediate adhesive layer. The separating films have a total layer thickness of preferably 15 to 30 μm and are therefore neither dimensionally stable nor deep-drawable.

US 2012/0175043 discloses a method for applying multiple polymeric coatings to a fibrous substrate, in particular a method for applying multiple polymeric coatings to fibrous substrates, without regard to chemical or physical incompatibilities of the polymeric coating materials.

WO 2013/160437 discloses a composite comprising a (i) plastic molded part or (ii) a semi-finished plastic product with a protective coating system, wherein the protective coating system comprises a plastic film and a plasma polymeric organosilicon layer. WO 2013/160437 further relates to the use of a temporary protective film as a separating aid for the mold or between the mold and the resulting plastic molded part in a plastic molding process and a method for producing a composite comprising a plastic molded part and a temporary protective film.

US 2015/0266276 discloses a composite comprising (i) a plastic component or (ii) a semi-finished plastic product having a protective coating system, wherein the protective coating system comprises a plastic film and an organosilicon plasma polymer layer, wherein the organosilicon plasma polymer layer is disposed between the (i) plastic component or (ii) semi-finished plastic product and the plastic film; and wherein after curing of the (i) plastic component or (ii) semi-finished plastic product, the organosilicon plasma polymer layer adheres better to the plastic film than to the (i) plastic component or the (ii) semi-finished plastic product.

WO 2017/068152 discloses a composite component (10) which is characterized by the following layer structure: a) a layer (11) which consists at least partially of polyethylene, b) a layer (12) which consists at least partly of a polyurethane and/or elastomer, c) at least one layer (13) which consists at least partly of a plastic reinforced by means of fibers (14), or which consists at least partly of an adhesive, the layer (12) being arranged directly between the layer (11) and the layer (13), the layers (11) and (12) having been joined in a first operation to form a laminate composite and the layer (13) having been joined in a second operation to the laminate composite comprising the layers (11) and (12).

DE 10 2007 010071 A1 relates to a laminate comprising a lacquer layer and a separating layer and a lacquer-carrier arrangement for transferring lacquer. The layer composite comprises a lacquer layer and a separating layer, wherein (a) the lacquer layer consists of an uncured and/or partially cured and/or cured lacquer and (b) the separating layer is a plasma polymer layer consisting of carbon, silicon, oxygen and hydrogen and optionally conventional impurities.

There is a need for separating films which are suitable for the production of fiber composite plastic components, in particular by a vacuum infusion process, and which have advantages over the prior art. The separating films should make the use of liquid separating agents superfluous in the production of fiber composite plastic components. Furthermore, the separating films should be producible from carrier films that are available by blown film coextrusion and offer an intrinsic separating effect. The separating films should also be deep-drawable and be able to withstand the temperatures generated during the exothermic curing process of the plastic resin. In addition, the separating films should be able to remain on the surfaces of the cured fiber composite plastic components for a certain period of time in order to act as a protective film, but at a given time should be removable from them without difficulty in order to expose the surface of the fiber composite plastic components. Furthermore, the separating films on the side facing away from the fiber composite plastic components, i.e. the outside, should have sufficient separating properties compared to so-called “tacky tapes”, which are usually used for bonding webs of separating films together or for fixing (bagging) films to the tool mold.

This object is achieved by the subject matter of the claims.

It was surprisingly found that deep-drawable separating films can be provided, which, after thermoforming, reproduce the mold for a fiber composite plastic component one-to-one like a protective skin, so that damage to the mold surface is no longer possible.

Furthermore, it was surprisingly found that separating films can be produced which support the deep drawing of the separating film at low forces due to a comparatively high stretchability. The use of the separating film according to the invention results in a very even surface of the cured fiber composite plastic component. The need for reworking the surface is thus significantly reduced, ideally completely avoided. Process cost advantages can be achieved by saving material (separating agent, filler) and working time for applying the filler and grinding the surface. At the same time, there are advantages in terms of employee health protection, as there is no need to handle the separating agent and the employees are no longer exposed to fine dust when grinding the surface of the cured fiber composite plastic component.

In addition, it was surprisingly found that deep-drawable separating films can be provided which do not require a release coating based on silicone compounds and have intrinsic release properties relative to the plastic resins used, whereby the release properties are achieved solely via the composition of the separating film.

A further advantage of the separating film according to the invention is that it can remain on the surface of the cured fiber composite plastic component for a longer period of time, 3-6 months depending on the climate zone, even outdoors, and thus offers protection of the surface against environmental influences during the storage period.

Furthermore, it was surprisingly found that the first surface layer facing the mold, which is based on a thermoplastic polyester elastomer, has sufficient release properties towards the mold. This allows the separating film according to the invention to be repositioned when inserted into the mold. The low force absorption and the plastic deformation of the separating film according to the invention, which already starts at low elongations, have the additional advantage that the separating film does not exert any horizontal tensile forces on the “tacky tape” in the deep-drawn state; leakages are thus avoided.

Furthermore, it was surprisingly found that the time required for reworking the fiber composite plastic component can be significantly reduced by using the separating film according to the invention. This reduces costs that are usually incurred by the reworking of the fiber composite plastic component (e.g. due to the premises required for processing, such as halls or hall areas, maintenance costs for equipment for processing the surface, such as grinding equipment, and disposal costs for grinding waste, such as dust and sandpaper).

A first aspect of the invention relates to a multilayer separating film comprising
a first surface layer based on a mixture of a thermoplastic elastomer and a polyolefin;
an adhesion promoting layer;
optionally a first intermediate layer;
optionally a second intermediate layer; and
a second surface layer based on at least one polypropylene or propylene copolymer;
wherein the separating film has a total layer thickness in the range of 10 to 250 μm.

The first surface layer and the second surface layer flank the two outer surfaces of the separating film according to the invention. Accordingly, the first surface layer and the second surface layer are each in direct contact with a further layer of the separating film according to the invention on only one of their two sides; the respective opposite layer forms the outer surface of the separating film according to the invention.

When the separating film according to the invention is used to produce a fiber composite plastic component in a mold, the first surface layer is intended to face the mold, whereas the second surface layer comes into contact with the curable plastic resin and adheres thereto in a detachable manner. In the composite of separating film and fiber composite plastic component, the first surface layer of the separating film then forms the outside of the composite, while the second surface layer of the separating film forms the inside of the composite.

The first intermediate layer and the second intermediate layer are each optional independently of one another.

In preferred embodiments
(i) the separating film according to the invention consists of the first surface layer, the adhesion promoting layer and the second surface layer;
(ii) the separating film according to the invention comprises or consists of the first surface layer, the adhesion promoting layer, the first intermediate layer and the second surface layer; or
(iii) the separating film according to the invention comprises or consists of the first surface layer, the adhesion promoting layer, the first intermediate layer, the second intermediate layer and the second surface layer;
preferably in each case in the aforementioned sequence of layers.

In principle, any other layers may be present in addition to the aforementioned layers. The separating film according to the invention thus has at least three layers, but can in principle also have four, five, six, seven or more layers, with a five-layer structure being preferred.

Unless expressly stated otherwise, percentages are percentages by weight. Unless expressly stated otherwise, standards such as EN ISO, ASTM, FINAT, etc. in the version valid on Jan. 1, 2021 shall apply.

Unless expressly stated otherwise, the term “based on” means that the named component is the main ingredient by weight, and in turn may be a mixture of several ingredients. The main component does not necessarily have to make up more than 50% by weight; there must simply be no other component whose weight proportion is greater.

The first surface layer of the separating film according to the invention is based on a mixture of a thermoplastic elastomer and a polyolefin.

It was surprisingly found that the mixture of a thermoplastic elastomer and a polyolefin according to the invention has particular advantages, especially when these are incompatible with each other. This is the case, for example, when the thermoplastic elastomer is a thermoplastic polyester elastomer and the polyolefin is a polyethylene, in particular LLDPE. The polyethylene then acts as an anti-blocking agent in the thermoplastic polyester elastomer, which creates a surface roughness which is advantageous for blown film coextrusion and which cannot or can hardly be achieved with conventional anti-blocking agents such as talcum masterbatch. This prevents wrinkling and sticking to the rollers during the extrusion process, which leads, for example, to an improvement in blown film coextrusion.

In addition, it was surprisingly found that the first surface layer has a sufficient separating effect compared to the “tacky tapes” coated with butyl adhesive, which are used to seal the mold.

Thermoplastic elastomers are known to a person skilled in the art and are commercially available. At room temperature, they behave similarly to conventional, i.e. non-thermoplastic elastomers, but can be plastically deformed when heat is applied and thus exhibit thermoplastic behavior. Preferred thermoplastic elastomers according to the invention are selected from the group consisting of thermoplastic polyamide elastomers; thermoplastic polyester elastomers (copolyester elastomers); olefin-based thermoplastic elastomers, e.g. polypropylene/ethylene-propylene-diene rubber (PP/EPDM); thermoplastic styrene block copolymers (styrene-butadiene-styrene block copolymers (SBS), styrene-ethylene-butylene-styrene block copolymers (SEBS), styrene-ethylene-propylene-styrene block copolymers (SEPS), styrene-ethylene-ethylene-propylene-styrene block copolymers (SEEPS) and methyl acrylate-butadiene-styrene copolymers (MBS), styrene-isoprene-styrene block copolymers (SIS), styrene-isoprene-butylene copolymers (SIBS)); urethane-based thermoplastic elastomers; and thermoplastic vulcanizates or cross-linked olefin-based thermoplastic elastomers, e.g. PP/EPDM. E.G. PP/EPDM.

Preferably, the thermoplastic elastomer is a thermoplastic polyester elastomer. Thermoplastic polyester elastomers are known to a person skilled in the art and are commercially available, for example under the trade names Hytrel® (Du Pont), Keyflex® (LG Chem), and Skypel® (SK Chemicals).

In particularly preferred embodiments, the thermoplastic elastomer in the first surface layer has a DSC melting temperature according to ISO 11357-3
of at least 150° C.; preferably at least 155° C., more preferably at least 160° C., still more preferably at least 165° C.; and/or
of at most 190° C.; preferably at most 185° C., more preferably at most 180° C., still more preferably at most 175° C.; and/or
in the range of 170±24° C.; preferably 170±16° C., more preferably 170±8° C.

Thermoplastic elastomers, in particular thermoplastic polyester elastomers with such properties, are known to a person skilled in the art and are commercially available, for example as Hytrel® G4078 NC010.

Polyolefins are known to a person skilled in the art and are commercially available. Preferably, the polyolefin is selected from the group consisting of polyethylene (PE), polypropylene (PP), polymethylpentene (PMP), polyisobutylene (PIB), polybutylene (PB, polybutene-1), copolymers and/or mixtures thereof.

Preferred polyethylenes include low-density polyethylene (LDPE/PE-LD), linear low-density polyethylene (LLDPE/PE-LLD), high-density polyethylene (HDPE/PE-HD), LLDPE being particularly preferred.

Preferred polypropylenes include atactic polypropylene, isotactic polypropylene, syndiotactic polypropylene and heterophasic polypropylene. Heterophasic polypropylene is typically a copolymer of ethylene and propylene, typically polymerized using Ziegler-Natta catalysts.

Preferably, the polyolefin in the first surface layer is a polyethylene or an ethylene copolymer; preferably an LLDPE.

In particularly preferred embodiments, the polyolefin in the first surface layer has a melt flow index MFI 190° C., 2.16 kg according to ISO 1133
of at least 0.7 g/10 min; preferably at least 0.8 g/10 min, more preferably at least 0.9 g/10 min, even more preferably at least 1.0 g/10 min; and/or
of at most 1.5 g/10 min; preferably at most 1.4 g/10 min, more preferably at most 1.3 g/10 min, still more preferably at most 1.2 g/10 min; and/or
in the range of 1.1±0.3 g/10 min; preferably 1.1±0.2 g/10 min, more preferably 1.1±0.1 g/10 min.

In particularly preferred embodiments, the polyolefin in the first surface layer has a VICAT softening temperature according to ASTM D1525
of at least 96° C.; preferably at least 98° C., more preferably at least 100° C., even more preferably at least 102° C.; and/or
of at most 112° C.; preferably at most 110° C., more preferably at most 108° C., still more preferably at most 106° C.; and/or
in the range of 104±9° C.; preferably 104±6° C.; more preferably 104±3° C.

In particularly preferred embodiments, the polyolefin in the first surface layer has a density according to ASTM D792
of at least 0.900 g/cm³; preferably at least 0.905 g/cm³, more preferably at least 0.910 g/cm³, even more preferably at least 0.915 g/cm³; and/or
of at most 0.940 g/cm³; preferably at most 0.935 g/cm³, more preferably at most 0.930 g/cm³, even more preferably at most 0.925 g/cm³; and/or
in the range of 0.919±0.020 g/cm³; preferably 0.919±0.015 g/cm³, more preferably 0.919±0.010 g/cm³, still more preferably 0.919±0.005 g/cm³.

Polyolefins, in particular polyethylenes or ethylene copolymers such as LLDPE with such properties are known to a person skilled in the art and are commercially available, for example as Dowlex® NG 5056 G.

In preferred embodiments, the proportion by weight of the thermoplastic elastomer in the first surface layer is greater than the proportion by weight of the polyolefin.

Preferably, the proportion by weight of the thermoplastic elastomer in the first surface layer is in the range of 72±25% by weight, based on the total weight of the first surface layer; preferably 72±20% by weight, more preferably 72±15% by weight, even more preferably 72±10% by weight, most preferably 72±5% by weight.

Preferably, the percentage by weight of the polyolefin in the first surface layer is in the range of 10±9% by weight, based on the total weight of the first surface layer; preferably 10±8% by weight, more preferably 10±7% by weight, even more preferably 10±6% by weight, most preferably 10±5% by weight.

The layer thickness of the first surface layer
is preferably at least 5 μm; preferably at least 6 μm, more preferably at least 7 μm, even more preferably at least 8 μm; and/or
is preferably at most 13 μm; preferably at most 12 μm, more preferably at most 11 μm, even more preferably at most 10 μm; and/or
is preferably in the range of 9±7 μm; preferably 9±5 μm, more preferably 9±3 μm.

The second surface layer of the separating film according to the invention is based on at least one polypropylene or propylene copolymer.

Preferably, the at least one polypropylene or propylene copolymer in the second surface layer comprises at least one heterophasic polypropylene.

Preferably, the proportion by weight of the at least one polypropylene or propylene copolymer in the second surface layer is in the range of 88±12% by weight, based on the total weight of the second surface layer; preferably 88±10% by weight, more preferably 88±8% by weight, even more preferably 88±6% by weight, most preferably 88±4% by weight.

In particularly preferred embodiments, the at least one polypropylene or propylene copolymer in the second surface layer is a mixture of a first heterophasic polypropylene and a second heterophasic polypropylene different therefrom.

It was surprisingly found that the extrusion bubble can be stabilized in blown film coextrusion when a blend of two different heterophasic polypropylenes is used.

Preferably, the proportion by weight of the first heterophasic polypropylene in the second surface layer is at most 60% by weight, based on the total weight of the second surface layer; preferably at most 50% by weight, more preferably at most 40% by weight, even more preferably at most 30% by weight.

Preferably, the proportion by weight of the first heterophasic polypropylene in the second surface layer is in the range of 20±12% by weight, based on the total weight of the second surface layer; preferably 20±10% by weight, more preferably 20±8% by weight, still more preferably 20±6% by weight, most preferably 20±4% by weight.

Preferably, the first heterophasic polypropylene has a lower melt flow rate and/or a lower DSC melting temperature than the second heterophasic polypropylene.

In particularly preferred embodiments, the first heterophasic polypropylene has a melt flow rate MFR 230° C., 2.16 kg according to ISO 1133-1
of at least 0.2 g/10 min; preferably at least 0.3 g/10 min, more preferably at least 0.4 g/10 min, even more preferably at least 0.5 g/10 min; and/or
of at most 1.0 g/10 min; preferably at most 0.9 g/10 min, more preferably at most 0.8 g/10 min, even more preferably at most 0.7 g/10 min; and/or
in the range of 0.6±0.3 g/10 min; preferably 0.6±0.2 g/10 min, more preferably 0.6±0.1 g/10 min;

In particularly preferred embodiments, the first heterophasic polypropylene has a DSC melting temperature according to ISO 11357-3
of at least 125° C.; preferably at least 130° C., more preferably at least 135° C., still more preferably at least 140° C.; and/or
of at most 165° C.; preferably at most 155° C., more preferably at most 150° C., still more preferably at most 145° C.; and/or
in the range of 142±24° C.; preferably 142±16° C., more preferably 142±8° C.

Heterophasic polypropylenes with such properties are known to a person skilled in the art and are commercially available, for example as Adflex® Q 100 F.

Preferably, the proportion by weight of the second heterophasic polypropylene in the second surface layer is at least 30% by weight, based on the total weight of the second surface layer; preferably at least 40% by weight, more preferably at least 50% by weight, even more preferably at least 60% by weight.

Preferably, the proportion by weight of the second heterophasic polypropylene in the second surface layer is in the range of 68±12% by weight, based on the total weight of the second surface layer; preferably 68±10% by weight, more preferably 68±8% by weight, still more preferably 68±6% by weight, most preferably 68±4% by weight.

In particularly preferred embodiments, the second heterophasic polypropylene has a melt flow rate MFR 230° C., 2.16 kg according to ISO 1133-1
of at least 0.5 g/10 min; preferably at least 0.6 g/10 min, more preferably at least 0.7 g/10 min, even more preferably at least 0.8 g/10 min; and/or
of at most 1.2 g/10 min; preferably at most 1.1 g/10 min, more preferably at most 1.0 g/10 min, even more preferably at most 0.9 g/10 min; and/or
in the range of 0.85±0.3 g/10 min; preferably 0.85±0.2 g/10 min, more preferably 0.85±0.1 g/10 min.

In particularly preferred embodiments, the second heterophasic polypropylene has a DSC melting temperature according to ISO 11357-3
of at least 150° C.; preferably at least 155° C., more preferably at least 160° C., still more preferably at least 165° C.; and/or
of at most 185° C.; preferably at most 180° C., more preferably at most 175° C., still more preferably at most 170° C.; and/or
in the range of 166±24° C.; preferably 166±16° C., more preferably 166±8° C.

Heterophasic polypropylenes with such properties are known to a person skilled in the art and are commercially available, for example as Borealis® BA110CF.

Preferably, the layer thickness of the second surface layer is greater than the layer thickness of the first surface layer.

The layer thickness of the second surface layer
is preferably at least 6 μm; preferably at least 8 μm, more preferably at least 10 μm, even more preferably at least 12 μm; and/or
is preferably at most 22 μm; preferably at most 20 μm, more preferably at most 18 μm, still more preferably at most 16 μm; and/or
is preferably in the range of 14±12 μm; preferably 14±9 μm, more preferably 14±6 μm.

The separating film according to the invention comprises an adhesion promoting layer. For this purpose, the adhesion promoting layer is typically based on a material which is compatible in each case with the materials on which the two layers directly adjacent to the adhesion promoting layer are based. Suitable materials are known to a person skilled in the art and are commercially available.

Preferably, these two layers immediately adjacent to the adhesion promoting layer are the first surface layer and either the first intermediate layer or the second surface layer.

Accordingly, the adhesion promoting layer is preferably arranged between the first surface layer and the first intermediate layer. Preferably, the adhesion promoting layer is directly adjacent to the first surface layer. Preferably, the adhesion promoting layer is directly adjacent (with its opposite side) to the first intermediate layer.

Preferably, the adhesion promoting layer is based on an ethylene-acrylate copolymer. Ethylene-acrylate copolymers which are suitable for producing such adhesion promoting layers are known to a person skilled in the art and are commercially available.

It was surprisingly found that ethylene-acrylate copolymers exhibit a good adhesion promoting effect, whereas conventional adhesion promoters, e.g. based on polyethylene, polypropylene or elastomers, which are grafted with maleic anhydride, do not exhibit a sufficient adhesion promoting effect.

The adhesion promoting layer is preferably non-reactive, i.e. it differs from conventional reactive adhesives and other conventional adhesion promoters. This ensures that the separating film according to the invention can be thermoformed, in particular deep-drawn, or cold-formed. Preferably, the adhesion promoting layer is essentially based exclusively on thermoplastic polymers.

The separating film according to the invention preferably has such a high bond strength that the layers cannot be separated under the usual measurement conditions specified for determining the bond strength, i.e. delamination under stress conditions is prevented. This is ensured, among other things, by the adhesion promoting layer.

In particularly preferred embodiments, the ethylene-acrylate copolymer has a melt flow index MFI 190° C., 2.16 kg according to ISO 1133
of at least 1.6 g/10 min; preferably at least 1.7 g/10 min, more preferably at least 1.8 g/10 min, even more preferably at least 1.9 g/10 min; and/or
of at most 2.4 g/10 min; preferably at most 2.3 g/10 min, more preferably at most 2.2 g/10 min, even more preferably at most 2.1 g/10 min; and/or
in the range of 2.0±0.3 g/10 min; preferably 2.0±0.2 g/10 min, more preferably 2.0±0.1 g/10 min;

In particularly preferred embodiments, the ethylene-acrylate copolymer has a DSC melting temperature according to ISO 11357-3
of at least 75° C.; preferably at least 80° C., more preferably at least 85° C., still more preferably at least 90° C.; and/or
of at most 110° C.; preferably at most 105° C., more preferably at most 100° C., still more preferably at most 95° C.; and/or
in the range of 91±12° C.; preferably 91±8° C., more preferably 91±4° C.;

In particularly preferred embodiments, the ethylene-acrylate copolymer has a VICAT softening temperature according to ASTM D1525
of at least 40° C.; preferably at least 42° C., more preferably at least 44° C., still more preferably at least 46° C.; and/or
of at most 65° C.; preferably at most 60° C., more preferably at most 55° C., still more preferably at most 50° C.; and/or
in the range of 48±12° C.; preferably 48±8° C., more preferably 48±4° C.

Ethylene-acrylate copolymers with such properties are known to a person skilled in the art and are commercially available, for example as Bynel® 22E 780.

Preferably, the proportion by weight of the ethylene-acrylate copolymer in the adhesion promoting layer is at least 75% by weight, based on the total weight of the adhesion promoting layer; more preferably at least 80% by weight, more preferably at least 85% by weight, even more preferably at least 90% by weight, most preferably at least 95% by weight.

The layer thickness of the adhesion promoting layer
is preferably at least 0.5 μm; preferably at least 1.0 μm, more preferably at least 1.5 μm, even more preferably at least 2.0 μm; and/or
is preferably at most 7 μm; preferably at most 6 μm, more preferably at most 5 μm, even more preferably at most 4 μm; and/or
is preferably in the range of 3±2 μm; preferably 3±1 μm.

The separating film according to the invention preferably has a first intermediate layer in addition to the first surface layer and the second surface layer an adhesion promoting layer.

If the separating film according to the invention also has a second intermediate layer, the first intermediate layer preferably has a greater layer thickness than the second intermediate layer.

It was surprisingly found that the first intermediate layer, possibly in cooperation with the second intermediate layer, improves the properties of the separating film according to the invention. It was surprisingly found that comparatively soft, deep-drawable intermediate layers with a temperature resistance>140° C. are advantageous, since temperature peaks of up to 135° C. can be reached during exothermic curing of the plastic resin, e.g. epoxy resin.

In preferred embodiments, the first intermediate layer is arranged between the adhesion promoting layer and the second intermediate layer. In preferred embodiments, the first intermediate layer is directly adjacent to the adhesion promoting layer. In preferred embodiments, the first intermediate layer is directly adjacent (on its opposite side) to the second intermediate layer.

The layer thickness of the first intermediate layer
is preferably at least 5 μm; preferably at least 6 μm, more preferably at least 7 μm, even more preferably at least 8 μm; and/or
is preferably at most 16 μm; preferably at most 14 μm, more preferably at most 12 μm, even more preferably at most 10 μm; and/or
is preferably in the range of 9±8 μm; preferably 9±6 μm, more preferably 9±4 μm.

Preferably, the first intermediate layer is based on at least one polypropylene or propylene copolymer, preferably on at least one heterophasic polypropylene.

In particularly preferred embodiments, the first intermediate layer is based on a mixture of a third heterophasic polypropylene and a fourth heterophasic polypropylene.

In preferred embodiments, in the first intermediate layer, the third heterophasic polypropylene has a lower melt flow rate and/or a higher DSC melting temperature than the fourth heterophasic polypropylene.

Preferably, the proportion by weight of the third heterophasic polypropylene in the first intermediate layer is in the range from 0 to 83.5% by weight, based on the total weight of the first intermediate layer. Preferably, the proportion by weight of the third heterophasic polypropylene in the first intermediate layer is in the range of 34±12% by weight, based on the total weight of the first intermediate layer; preferably 34±10% by weight, more preferably 34±8% by weight, even more preferably 34±6% by weight, most preferably 34±4% by weight.

In a further preferred embodiment, the proportion by weight of the third heterophasic polypropylene in the first intermediate layer is in the range of 58±12% by weight, based on the total weight of the first intermediate layer; preferably 58±10% by weight, more preferably 58±8% by weight, still more preferably 58±6% by weight, most preferably 58±4% by weight.

In a further preferred embodiment, the proportion by weight of the third heterophasic polypropylene in the first intermediate layer, based on the total weight of the first intermediate layer, is
at least 35% by weight, preferably at least 40% by weight, more preferably at least 45% by weight, even more preferably at least 50% by weight, most preferably at least 55% by weight; and/or
at most 55% by weight, preferably at most 50% by weight, more preferably at most 45% by weight, even more preferably at most 40% by weight, most preferably at most 35% by weight.

Preferably, the proportion by weight of the fourth heterophasic polypropylene in the first intermediate layer is in the range from 0 to 83.5% by weight, based on the total weight of the first intermediate layer. Preferably, the proportion by weight of the fourth heterophasic polypropylene in the first intermediate layer is in the range of 48±12% by weight, based on the total weight of the first intermediate layer; preferably 48±10% by weight, more preferably 48±8% by weight, even more preferably 48±6% by weight, most preferably 48±4% by weight.

In a further preferred embodiment, the proportion by weight of the fourth heterophasic polypropylene in the first intermediate layer is in the range of 40±6% by weight, based on the total weight of the first intermediate layer; preferably 40±4% by weight, more preferably 40±2% by weight.

In a further preferred embodiment, the proportion by weight of the fourth heterophasic polypropylene in the first intermediate layer, based on the total weight of the first intermediate layer, is
at least 40% by weight, preferably at least 45% by weight; and/or
at most 50% by weight, preferably at most 45% by weight, more preferably at most 40% by weight.

The separating film according to the invention preferably has a second intermediate layer in addition to the first surface layer, the second surface layer, the adhesion promoting layer and the first intermediate layer, if present.

In preferred embodiments, the second intermediate layer is arranged between the first intermediate layer and the second surface layer. In preferred embodiments, the second intermediate layer is directly adjacent to the first intermediate layer. In preferred embodiments, the second intermediate layer is directly adjacent (on its opposite side) to the second surface layer.

The layer thickness of the second intermediate layer
is preferably at least 1 μm; preferably at least 2 μm, more preferably at least 3 μm, even more preferably at least 4 μm; and/or
is preferably at most 9 μm; preferably at most 8 μm, more preferably at most 7 μm, even more preferably at most 6 μm; and/or
is preferably in the range of 5±4 μm; preferably 5±3 μm, more preferably 5±2 μm.

Preferably, the second intermediate layer is based on at least one polypropylene or propylene copolymer; preferably on at least one heterophasic polypropylene.

In particularly preferred embodiments, the second intermediate layer is based on a mixture of a fifth heterophasic polypropylene and a sixth heterophasic polypropylene different therefrom.

In preferred embodiments, in the second intermediate layer, the fifth heterophasic polypropylene has a lower melt flow rate and/or a higher DSC melting temperature than the sixth heterophasic polypropylene.

Preferably, the proportion by weight of the fifth heterophasic polypropylene in the second intermediate layer is in the range from 0 to 83.5% by weight, based on the total weight of the second intermediate layer. Preferably, the proportion by weight of the fifth heterophasic polypropylene in the second intermediate layer is in the range of 34±12% by weight, based on the total weight of the second intermediate layer; preferably 34±10% by weight, more preferably 34±8% by weight, even more preferably 34±6% by weight, most preferably 34±4% by weight.

In a further preferred embodiment, the proportion by weight of the fifth heterophasic polypropylene in the second intermediate layer is in the range of 56±12% by weight, based on the total weight of the second intermediate layer; preferably 56±10% by weight, more preferably 56±8% by weight, still more preferably 56±6% by weight, most preferably 56±4% by weight.

In a further preferred embodiment, the proportion by weight of the fifth heterophasic polypropylene in the second intermediate layer, based on the total weight of the second intermediate layer, is
at least 35% by weight, preferably at least 40% by weight, more preferably at least 45% by weight, even more preferably at least 50% by weight, most preferably at least 55% by weight; and/or
at most 55% by weight, preferably at most 50% by weight, more preferably at most 45% by weight, even more preferably at most 40% by weight, most preferably at most 35% by weight.

Preferably, the proportion by weight of the sixth heterophasic polypropylene in the second intermediate layer is in the range from 0 to 83.5% by weight, based on the total weight of the second intermediate layer. Preferably, the proportion by weight of the sixth heterophasic polypropylene in the second intermediate layer is in the range of 50±12% by weight, based on the total weight of the second intermediate layer; preferably 50±10% by weight, more preferably 50±8% by weight, even more preferably 50±6% by weight, most preferably 50±4% by weight.

In a further preferred embodiment, the proportion by weight of the sixth heterophasic polypropylene in the second intermediate layer is in the range of 40±8% by weight, based on the total weight of the second intermediate layer; preferably 40±6% by weight, more preferably 40±4% by weight, still more preferably 40±2% by weight.

In a further preferred embodiment, the proportion by weight of the fourth heterophasic polypropylene in the first intermediate layer, based on the total weight of the first intermediate layer, is
at least 40% by weight, preferably at least 45% by weight, more preferably at least 50% by weight; and/or
at most 50% by weight, preferably at most 45% by weight, more preferably at most 40% by weight.

In a further preferred embodiment, the separating film according to the invention has, in addition to the first surface layer and the second surface layer and the adhesion promoting layer, a first intermediate layer and a second intermediate layer, wherein
the first intermediate layer is based on a mixture of a third heterophasic polypropylene and a fourth heterophasic polypropylene which is different therefrom;
the second intermediate layer is based on a mixture of a fifth heterophasic polypropylene and a sixth heterophasic polypropylene different therefrom;
the proportion by weight of the third heterophasic polypropylene in the first intermediate layer is in the range of 34±12% by weight, based on the total weight of the first intermediate layer; preferably 34±10% by weight, more preferably 34±8% by weight, even more preferably 34±6% by weight, most preferably 34±4% by weight;
the proportion by weight of the fourth heterophasic polypropylene in the first intermediate layer is in the range of 48±6% by weight, based on the total weight of the first intermediate layer; preferably 48±4% by weight, more preferably 48±2% by weight;
the proportion by weight of the fifth heterophasic polypropylene in the second intermediate layer is in the range of 34±12% by weight, based on the total weight of the second intermediate layer; preferably 34±10% by weight, more preferably 34±8% by weight, even more preferably 34±6% by weight, most preferably 34±4% by weight;
the proportion by weight of the sixth heterophasic polypropylene in the second intermediate layer is in the range of 50±8% by weight, based on the total weight of the second intermediate layer; preferably 50±6% by weight, more preferably 50±4% by weight, still more preferably 50±2% by weight.

In a further preferred embodiment, the separating film according to the invention has, in addition to the first surface layer and the second surface layer and the adhesion promoting layer, a first intermediate layer and a second intermediate layer, wherein
the first intermediate layer is based on a mixture of a third heterophasic polypropylene and a fourth heterophasic polypropylene which is different therefrom;
the second intermediate layer is based on a mixture of a fifth heterophasic polypropylene and a sixth heterophasic polypropylene different therefrom;
the proportion by weight of the third heterophasic polypropylene in the first intermediate layer is in the range of 58±12% by weight, based on the total weight of the first intermediate layer; preferably 58±10% by weight, more preferably 58±8% by weight, even more preferably 58±6% by weight, most preferably 58±4% by weight;
the proportion by weight of the fourth heterophasic polypropylene in the first intermediate layer is in the range of 40±6% by weight, based on the total weight of the first intermediate layer; preferably 40±4% by weight, more preferably 40±2% by weight;
the proportion by weight of the fifth heterophasic polypropylene in the second intermediate layer is in the range of 56±12% by weight, based on the total weight of the second intermediate layer; preferably 56±10% by weight, more preferably 56±8% by weight, even more preferably 56±6% by weight, most preferably 56±4% by weight;
the proportion by weight of the sixth heterophasic polypropylene in the second intermediate layer is in the range of 40±8% by weight, based on the total weight of the second intermediate layer; preferably 40±6% by weight, more preferably 40±4% by weight, still more preferably 40±2% by weight.

In preferred embodiments, the third heterophasic polypropylene in the first intermediate layer and/or the fifth heterophasic polypropylene in the second intermediate layer each independently have a melt flow rate MFR 230° C., 2.16 kg according to ISO 1133-1
of at least 0.2 g/10 min; preferably at least 0.3 g/10 min, more preferably at least 0.4 g/10 min, even more preferably at least 0.5 g/10 min; and/or
of at most 1.0 g/10 min; preferably at most 0.9 g/10 min, more preferably at most 0.8 g/10 min, even more preferably at most 0.7 g/10 min; and/or
in the range of 0.6±0.3 g/10 min; preferably 0.6±0.2 g/10 min, more preferably 0.6±0.1 g/10 min;

In preferred embodiments, the third heterophasic polypropylene in the first intermediate layer and/or the fifth heterophasic polypropylene in the second intermediate layer each independently have a DSC melting temperature according to ISO 11357-3
of at least 125° C.; preferably at least 130° C., more preferably at least 135° C., even more preferably at least 140° C.; and/or
of at most 165° C.; preferably at most 155° C., more preferably at most 150° C., still more preferably at most 145° C.; and/or
in the range of 142±24° C.; preferably 142±16° C., more preferably 142±8° C.

Heterophasic polypropylenes with such properties are known to a person skilled in the art and are commercially available, for example as Adflex® Q 100 F.

In preferred embodiments, the fourth heterophasic polypropylene in the first intermediate layer and/or the sixth heterophasic polypropylene in the second intermediate layer each independently have a melt flow rate MFR 230° C., 2.16 kg according to ISO 1133-1
of at least 0.4 g/10 min; preferably at least 0.5 g/10 min, more preferably at least 0.6 g/10 min, even more preferably at least 0.7 g/10 min; and/or
of at most 1.3 g/10 min; preferably at most 1.2 g/10 min, more preferably at most 1.1 g/1.0 min, even more preferably at most 0.9 g/10 min; and/or
in the range of 0.8±0.3 g/10 min; preferably 0.8±0.2 g/10 min, more preferably 0.8±0.1 g/10 min;

In preferred embodiments, the fourth heterophasic polypropylene in the first intermediate layer and/or the sixth heterophasic polypropylene in the second intermediate layer each independently have a DSC melting temperature according to ISO 11357-3
of at least 120° C.; preferably at least 125° C., more preferably at least 130° C., even more preferably at least 135° C.; and/or
of at most 165° C.; preferably at most 155° C., more preferably at most 150° C., still more preferably at most 145° C.; and/or
in the range of 140±24° C.; preferably 140±16° C., more preferably 140±8° C.

Heterophasic polypropylenes with such properties are known to a person skilled in the art and are commercially available, for example as Borsoft® SA 233 CF.

In preferred embodiments of the separating film according to the invention
(i) the first heterophasic polypropylene in the second surface layer and the third heterophasic polypropylene in the first intermediate layer are the same; and/or
(ii) the first heterophasic polypropylene in the second surface layer and the fifth heterophasic polypropylene in the second intermediate layer are the same; and/or
(iii) the third heterophasic polypropylene in the first intermediate layer and the fifth heterophasic polypropylene in the second intermediate layer are the same; and/or
(iv) the fourth heterophasic polypropylene in the first intermediate layer and the sixth heterophasic polypropylene in the second intermediate layer are the same.

In preferred embodiments of the separating film according to the invention
(i) the first heterophasic polypropylene in the second surface layer and the fourth heterophasic polypropylene in the first intermediate layer are different; and/or
(ii) the first heterophasic polypropylene in the second surface layer and the sixth heterophasic polypropylene in the second intermediate layer are different; and/or
(iii) the second heterophasic polypropylene in the second surface layer and the third heterophasic polypropylene in the first intermediate layer are different; and/or
(iv) the second heterophasic polypropylene in the second surface layer and the fourth heterophasic polypropylene in the first intermediate layer are different; and/or
(v) the second heterophasic polypropylene in the second surface layer and the fifth heterophasic polypropylene in the second intermediate layer are different; and/or
(vi) the second heterophasic polypropylene in the second surface layer and the sixth heterophasic polypropylene in the second intermediate layer are different; and/or
(vii) the third heterophasic polypropylene in the first intermediate layer and the sixth heterophasic polypropylene in the second intermediate layer are different; and/or
(viii) the fourth heterophasic polypropylene in the first intermediate layer and the fifth heterophasic polypropylene in the second intermediate layer are different.

Each layer of the separating film according to the invention may independently comprise additives conventionally used in such films. Examples of such additives are pigments, dyes, lubricants, antistatic agents, fillers, nucleating agents, plasticizers, lubricants, stabilizers, UV absorbers, etc., which can be used in conventional amounts according to the invention.

In preferred embodiments of the separating film according to the invention, the first intermediate layer and/or the second intermediate layer does not comprise an antistatic agent.

In preferred embodiments of the separating film according to the invention, the first intermediate layer and/or the second intermediate layer independently comprise an antistatic agent. Suitable antistatic agents are known to a person skilled in the art and are commercially available.

The proportion by weight of the antistatic agent is preferably in each case independently of one another in the range of 14±13% by weight, more preferably 14±10% by weight, even more preferably 14±7% by weight, most preferably 14±4% by weight, based on the total weight of the first intermediate layer or the second intermediate layer.

Preferably, the antistatic agent is based on polyether-polyamide block copolymer. Such antistatic agents are commercially available, for example as CESA-stat. For further details, reference can be made to DE 10 2010 025 938 A1, for example. It was surprisingly found that the addition of an antistatic agent in the first or second intermediate layer reduces the adhesion of dust.

In preferred embodiments of the separating film according to the invention, neither the first surface layer nor the second surface layer contains silicon compounds.

Preferably, the separating film according to the invention is planar, in particular not embossed.

The separating film according to the invention is preferably not oriented.

The separating film according to the invention typically has a machine direction (MD) and a cross direction (CD). These terms are known to a person skilled in the art. The “machine direction” is typically the direction in which a film is transported during the production process, the “cross direction” is typically at an angle of 90° to the “machine direction”.

The separating film according to the invention is preferably thermoplastic as such, i.e. it is preferably composed essentially entirely of thermoplastic polymers (and possibly additives), i.e. it preferably contains no thermosetting plastics, reactive adhesives, etc.

The separating film according to the invention is preferably thermoformable, preferably deep-drawable.

The term “deep-drawable” is known to a person skilled in the art. For the purpose of the description, “deep-drawable” in the sense of the invention preferably means
a tensile strength of preferably at least 10 N, or at least 12 N, or at least 14 N, or at least 16 N, or at least 18 N, or at least 20 N, or at least 22 N, or at least 24 N, or at least 26 N, or at least 28 N, or at least 30 N; in each case preferably in the machine direction (MD); or in the cross direction (CD); or in the machine direction and cross direction (MD and CD); and/or
a modulus of elasticity of preferably at least 350 MPa, or at least 370 MPa, or at least 390 MPa, or at least 410 MPa, or at least 430 MPa, or at least 450 MPa, or at least 470 MPa; in each case preferably in the machine direction (MD); or in the cross direction (CD); or in the machine direction and cross direction (MD and CD); and/or
an elongation at break of preferably at least 350%, or at least 375%, or at least 400%, or at least 425%, or at least 450%, or at least 475%, or at least 500%, or at least 525%, or at least 550%, or at least 575%, or at least 600%, or at least 625%, or at least 650%, or at least 675%, or at least 700%, or at least 725%, or at least 750%; in each case preferably in the machine direction (MD); or in the cross direction (CD); or in the machine direction and cross direction (MD and CD); and/or
a tensile force at 25% elongation of preferably less than 15 N, or less than 14 N, or less than 13 N, or less than 12 N, or less than 11 N, or less than 10 N, or less than 9 N, or less than 8 N, or less than 7 N, or less than 6 N, or less than 5 N; in each case preferably in the machine direction (MD); or in the cross direction (CD); or in the machine direction and cross direction (MD and CD);
in each case measured according to DIN EN ISO 527 on a 15 mm wide sample with a clamping length of 100.00 mm, a preload of 100 mN and a test speed of 500 mm/min.

The separating film according to the invention is preferably cold-formable. The term “cold-formable” preferably refers to formability at room temperature (23° C.).

The separating film according to the invention is preferably vacuum-tight. For the purpose of description, “vacuum-tight” in the sense of the invention preferably means that a vacuum created within a sealed envelope of the separating film is maintained for a sufficient period of time, possibly with continuous extraction of air, so that a molded part can be produced under vacuum from a semi-finished product located in the inner space. If the production of the molded part according to the invention comprises, for example, the curing of a plastic material in a vacuum and possibly with the addition of heat, the vacuum-tightness of the separating film according to the invention is sufficient to maintain the vacuum in the inner space until the plastic material is at least partially, preferably completely, cured, optionally with continuous extraction of air.

Preferably, the air permeability of the separating film according to ISO 15105-1:2007 is at most 2200 cm³ mm/m² day bar, more preferably at most 2100 cm³ mm/m² day bar, even more preferably at most 2000 cm³ mm/m² day bar, most preferably at most 1900 cm³ mm/m² day bar and in particular at most 1800 cm³ mm/m² day bar. Preferably, the oxygen permeability and/or the nitrogen permeability are also within the above-mentioned ranges.

Preferably, the separating film according to the invention has a total layer thickness in the range of 40±30 μm; preferably 40±25 μm, more preferably 40±20 μm, even more preferably 40±15 μm, still more preferably 40±10 μm, most preferably 40±5 μm.

Suitable methods for determining the total layer thickness of separating films and for determining the layer thickness of individual layers within the separating film are known to a person skilled in the art. According to the invention, the determination is preferably carried out microscopically on the microtome section, whereby the measured value is given as the average value of a total of 10 measurements.

In preferred embodiments, the separating film according to the invention is transparent. The term “transparent” in the sense of the invention means that a semi-finished fiber composite plastic product can be viewed with the naked eye through the separating film according to the invention. The transparency is preferably quantified with the aid of densitometers. Such methods are familiar to those skilled in the art. Preferably, haze can be measured as an optical value as a measure of transparency. The measurement of haze is preferably carried out according to ASTM test standard D 1003-61 m, Procedure A, after calibration of the measuring instrument with haze standards between 0.3 and 34% haze. A suitable measuring instrument is, for example, a Hazemeter from Byk-Gardner with an integrating sphere, which permits integrated measurement of diffuse light transmission in a solid angle of 8° to 160°. The separating films according to the invention preferably have a haze of less than 100%, more preferably less than 96%, even more preferably less than 92%, most preferably less than 88% and in particular less than 84%, as determined by the method described above; and/or a transparency of more than 45%, preferably more than 50%, more preferably more than 55%, still more preferably more than 60%, most preferably more than 65%; and/or a clarity of more than 8%, preferably more than 10%, more preferably more than 12%, still more preferably more than 14%, most preferably more than 16%.

In other preferred embodiments, the separating film according to the invention is opaque.

The separating film according to the invention can be produced by conventional methods useful for producing multilayer films, preferably extrusion processes, in particular blown film coextrusion or cast film extrusion, wherein blown film coextrusion is particularly preferred.

Another aspect of the invention relates to a method for producing a fiber composite plastic component from a curable fiber composite plastic semi-finished product comprising the steps of:
(a) providing a mold for producing a fiber composite plastic component, the mold having a shape which corresponds at least in one section to the shape of the fiber composite plastic component to be produced with the mold;
(b) introducing the separating film according to the invention, as described above, into the mold, wherein the separating film lines the mold at least in the section corresponding to the shape of the fiber composite plastic component to be produced with the mold; and wherein the first surface layer of the separating film faces the mold;
(c) optionally deep-drawing the separating film;
(d) introducing the curable fiber composite plastic semi-finished product into the mold, wherein the second surface layer of the separating film faces the curable fiber composite plastic semi-finished product;
(e) optionally closing and/or evacuating the mold;
(f) heating the mold to a temperature at which the curable fiber composite plastic semi-finished product cures; optionally under pressure;
(g) optionally cooling the cured fiber composite plastic component;
(h) optionally removing the cured fiber composite plastic component together with the separating film adhering to it from the mold; and
(i) optionally removing the separating film from the cured fiber composite plastic component.

In the manufacture of the fiber composite plastic component, the fiber composite plastic semi-finished product impregnated with the plastic resin to be cured, preferably an epoxy resin to be cured, is introduced into the mold in step (d) and sealed in a vacuum-tight manner in step (e). By applying a vacuum, the separating film according to the invention is compressed while compacting the fiber material. While maintaining the vacuum, the mold with the shaped laminate is heated in an autoclave to the curing temperature of the plastic resin to be cured and maintained for the entire curing time, usually for hours.

In addition to the process with an autoclave, it is also possible to work with press pressure or only under atmospheric pressure (i.e. curing in an oven). Curing can also be achieved by means of microwave radiation.

After the curing time and cooling in step (g), the fiber composite plastic component is removed from the mold in step (h) and packaged, preferably excluding the effects of moisture, until final use.

Preferably, the fiber composite plastic component comprises a further material selected from balsa wood, technical foams, glass nonwovens, carbon fibers, glass fibers, and combinations thereof.

Preferably, the fiber composite plastic semi-finished product comprises a curable epoxy resin or a curable polyester resin; preferably a curable epoxy resin.

Preferably, the fiber composite plastic component is intended for a means of transport, preferably for an aircraft, a spacecraft, a train or a motor vehicle, or is intended for a wind turbine, preferably for a rotor blade.

A further aspect of the invention relates to a fiber composite plastic component, to the outer surface of which the separating film according to the invention, as described above, adheres at least in a partial region and can be detached therefrom, preferably without leaving any residue, wherein the second surface layer of the separating film faces the fiber composite plastic component.

At the same time, the fiber composite plastic component is preferably intended for a means of transport, preferably for an aircraft, a spacecraft, a train or a motor vehicle, or for a wind turbine, preferably for a rotor blade.

A further aspect of the invention relates to the use of the separating film according to the invention, described above, as a separating film, preferably for the production of a fiber composite plastic component, particularly preferably in the method according to the invention, described above.

FIG. 1 shows a separating film (1) according to the invention in cross-section with a schematic preferred layer structure comprising a first surface layer (2), adhesion promoting layer (3), first intermediate layer (4), second intermediate layer (5) and second surface layer (6).

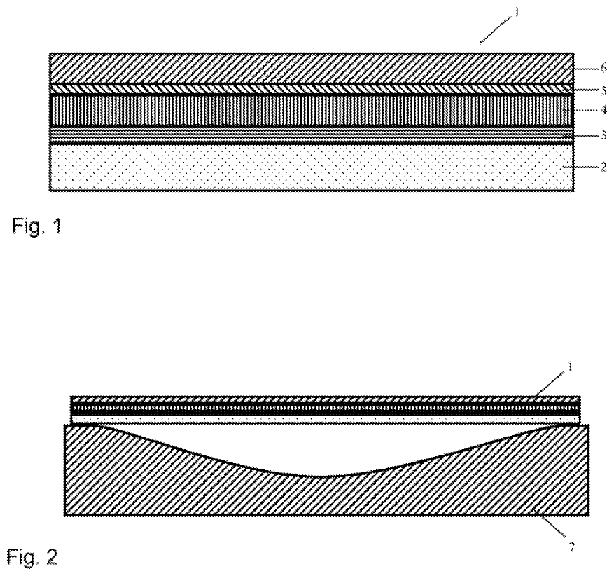

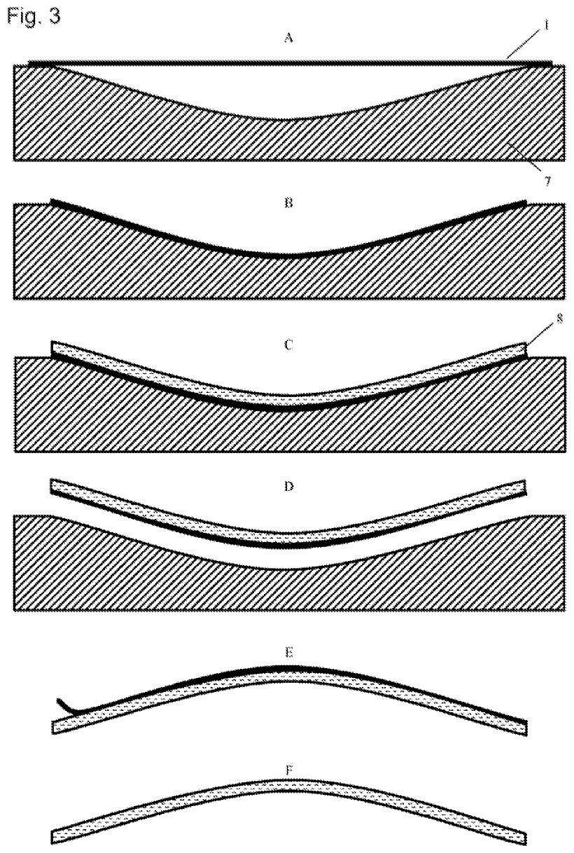

FIG. 2 shows schematically how the separating film (1) according to the invention is introduced into a mold (7) for producing a fiber composite plastic component, with the first surface layer (2) of the separating film (1) facing the mold (7). A person skilled in the art will recognize that the separating film (1) according to the invention does not usually have such a pronounced rigidity that it closes the mold (7) in a planar manner, as shown. Rather, the separating film (1) according to the invention typically exhibits a certain flexibility, so that it already adapts to a certain extent to the shape of the mold (7) without the need for special measures. However, a precise fit of the separating film (1) to the mold (7) according to the invention is preferably only achieved by deep drawing, for example after a vacuum has been applied between the mold (7) and the separating film (1).

FIG. 3 shows schematically how the separating film (1) according to the invention can be used to produce a fiber composite plastic component from a curable fiber composite plastic semi-finished product (8). FIG. 3A corresponds to the arrangement shown in FIG. 2, i.e. before the separating film is deep-drawn. FIG. 3B shows the deep-drawn separating film (1) in the mold (7). FIG. 3C shows how the curable fiber composite plastic semi-finished product (8) is applied to the separating film (1), with the second surface side of the separating film (1) facing the curable fiber composite plastic semi-finished product (8). FIG. 3D shows how the cured fiber composite semi-finished product is removed from the mold (7) together with the separating film (1) adhering to it. FIG. 3E shows how the separating film (1) can be removed from the cured fiber composite semi-finished product. Finally, FIG. 3E shows the finished, cured fiber composite plastic semi-finished product with the surface exposed.

### LIST OF REFERENCE NUMERALS

(1) separating film
(2) first surface layer
(3) adhesion promoting layer
(4) first intermediate layer
(5) second intermediate layer
(6) second surface layer
(7) mold for manufacturing a fiber composite plastic component
(8) curable fiber composite plastic semi-finished product

The following examples serve to explain the invention, but are not to be interpreted restrictively:

### Examples 1-3

Three separating films of the following structure and composition were produced:

| | | | Example | | | | | |
|---|---|---|---|---|---|---|---|---|
| | Polymer/ | | 1 | | 2 | | 3 | |
| Layer | additive | Trade name | % | μm | % | μm | % | μm |
| First | Thermoplastic | Hytrel ® G4078 | 72 | 9 | 72 | 9 | 72 | 14 |
| surface | elastomer | NC010 | | | | | | |
| layer | Polyolefin | Dowlex ® NG 5056 | 10 | | 10 | | 10 | |
| | | G | | | | | | |
| | Additive | | 18 | | 18 | | 18 | |
| | mixture | | | | | | | |
| Adhesion | Ethylene | Bynel ® 22E 780 | 98 | 3 | 98 | 3 | 98 | 3 |
| promoting | acrylate | | | | | | | |
| layer | copolymer | | | | | | | |
| | Additive | | 2 | | 2 | | 2 | |
| | mixture | | | | | | | |
| First | 3. hetero | Adflex ® Q100F | 34 | 9 | 58 | 9 | 58 | 9 |
| intermediate | PP | | | | | | | |
| layer | 4. hetero | Borsoft ® SA 233 CF | 48 | | 40 | | 40 | |
| | PP | | | | | | | |
| | Antistatic | CESA ® stat | 14 | | — | | — | |
| | agent | | | | | | | |
| | Additive | | 4 | | 2 | | 2 | |
| | mixture | | | | | | | |
| Second | 5. hetero | Adflex ® Q100F | 34 | 5 | 56 | 5 | 56 | 5 |
| intermediate | PP | | | | | | | |
| layer | 6. hetero | Borsoft ® SA 233 CF | 50 | | 40 | | 40 | |
| | PP | | | | | | | |
| | Antistatic | CESA ® stat | 14 | | — | | — | |
| | agent | | | | | | | |
| | Additive | | 2 | | 4 | | 4 | |
| | mixture | | | | | | | |
| Second | 1. hetero | Adflex ® Q 100 F | 20 | 14 | 20 | 14 | 20 | 14 |
| surface | PP | | | | | | | |
| layer | 2. hetero | Borealis ® BA110CF | 68 | | 68 | | 68 | |
| | PP | | | | | | | |
| | Additive | | 12 | | 12 | | 12 | |
| | mixture | | | | | | | |

All percentages are in % by weight.

The films according to examples 1 and 2 showed no curling and lay flat. The mechanical properties of these two films were examined in more detail. The following tables show the measurement results of the mechanical testing of the separating films (examples 1-2), each measured in the machine direction (MD) and cross direction (CD), each determined according to DIN EN ISO 527 on a 15 mm wide sample; clamping length: 100.00 mm, preload: 100 mN, test speed: 500 mm/min:

Measurement results for modulus of elasticity, elongation at break, tensile force and strength, and thickness

| | Modulus of | | | | |
|---|---|---|---|---|---|
| | Elasticity | Elongation at | Tensile | Tensile | Thickness |
| Example | [MPa] | break [%] | force [N] | strength [MPa] | [μm] |
| Example 1 | 411.9 ± 26.6 | 550.9 ± 32.9 | 29.6 ± 1.3 | 46 ± 1.8 | 43 ± 0.9 |
| (MD) | | | | | |
| Example 1 | 461.8 ± 16.3 | 737.5 ± 51.1 | 20.1 ± 1.5 | 31.3 ± 2.7 | 43 ± 1.4 |
| (CD) | | | | | |
| Example 2 | 400.1 ± 36.8 | 431.0 ± 15.3 | 21.4 ± 0.8 | 42.6 ± 3.0 | 33.7 ± 1.2 |
| (MD) | | | | | |
| Example 2 | 373.0 ± 20.3 | 645 ± 2.5 | 13.6 ± 0.6 | 26.7 ± 2.3 | 34.1 ± 1.7 |
| (CD) | | | | | |

### Measurement Results for Tensile Force and Elongation

| Example | F 1% [N] | F 2.5% [N] | F 5% [N] | F 10% [N] | F 25% [N] |
|---|---|---|---|---|---|
| Example 1 | 2.8 ± 0.2 | 5.9 ± 0.1 | 7.7 ± 0.1 | 9.5 ± 0.2 | 11.5 ± 0.3 |
| (MD) | | | | | |
| Example 1 | 3.5 ± 0.0 | 6.2 ± 0.0 | 7.7 ± 0.0 | 8.9 ± 0.1 | 9.3 ± 0.1 |
| (CD) | | | | | |
| Example 2 | 2.5 ± 0.1 | 4.5 ± 0.3 | 6.1 ± 0.4 | 7.9 ± 0.5 | 10.3 ± 0.6 |
| (MD) | | | | | |
| Example 2 | 2.4 ± 0.2 | 4.4 ± 0.2 | 5.7 ± 0.3 | 6.8 ± 0.3 | 7.2 ± 0.3 |
| (CD) | | | | | |

In addition, the air permeability of the films was measured according to example 1 and example 2. The measurement was carried out in accordance with ISO 15105-1 (2007-10) at 23° C. with air. The relative humidity was 0%. The flat side of the separating film was facing the test gas (air) in each case. The test results are summarized in the following table:

### Measurement Results for Air Permeability

| | Measurement | Measurement | Thickness of sample | | | Thickness of sample | | |
|---|---|---|---|---|---|---|---|---|
| | 1 | 2 | measurement 1 [μm] | | | measurement 2 [μm] | | |
| Example | [cm³ mm/m² day bar] | | Average | min | max | Average | min | max |
| Example | 1900 | 1700 | 42 | 40 | 44 | 42 | 39 | 43 |
| 1 | | | | | | | | |
| Example | 1800 | 1800 | 46 | 44 | 48 | 44 | 40 | 48 |
| 2 | | | | | | | | |

In addition, the transparency of the films was also measured according to example 1 and example 2. The measurements were carried out in accordance with ISO and ASTM. The measurement results are summarized in the following table.

### Measurement Results for Haze

| | Haze Gard ( ISO ) | | Haze Gard (ASTM) | | |
|---|---|---|---|---|---|
| [%] | Transparency | Haze | Transparency | Haze | Clarity |
| Example 1 | 64.7 | 86.6 | 66.5 | 94.1 | 13.0 |
| Example 2 | 47.9 | 93.0 | 50.4 | 100.0 | 10.8 |

What is claimed is:

1. A multilayer separating film comprising
a first surface layer based on a mixture of a thermoplastic elastomer and a polyolefin, wherein the proportion by weight of the thermoplastic elastomer is greater than the proportion by weight of the polyolefin;
an adhesion promoting layer;
optionally a first intermediate layer;
optionally a second intermediate layer; and
a second surface layer based on at least one polypropylene or propylene copolymer;
wherein the separating film has a total layer thickness in the range from 10 to 250 μm.

2. The separating film according to claim 1, wherein the thermoplastic elastomer in the first surface layer is a thermoplastic polyester elastomer.

3. The separating film according to claim 1, wherein the thermoplastic elastomer in the first surface layer has a DSC melting temperature according to ISO 11357-3 of at least 150° C.; preferably at least 155° C., more preferably at least 160° C., still more preferably at least 165° C.

4. The separating film according to claim 1, wherein the polyolefin in the first surface layer is a polyethylene or an ethylene copolymer; preferably an LLDPE.

5. The separating film according to claim 1, wherein the at least one polypropylene or propylene copolymer in the second surface layer is at least a heterophasic polypropylene.

6. The separating film according to claim 1, wherein the at least one polypropylene or propylene copolymer in the second surface layer is a mixture of a first heterophasic polypropylene and a second heterophasic polypropylene different therefrom.

7. The separating film according to claim 1, which is thermoformable, optionally wherein the separating film is deep-drawable.

8. The separating film according to claim 1, which is cold-formable.

9. Use of the separating film according to claim 1, as a separating film.

10. The use according to claim 9, for producing a fiber composite plastic component from a curable fiber composite plastic semi-finished product.

11. A method of manufacturing a fiber composite plastic component from a curable fiber composite plastic semi-finished product comprising the steps of:
(a) providing a mold for producing a fiber composite plastic component, the mold having a shape which corresponds at least in one section to the shape of the fiber composite plastic component to be produced with the mold;
(b) introducing a separating film according to claim 1, into the mold, wherein the separating film lines the mold at least in the section which corresponds to the shape of the fiber composite plastic component to be produced with the mold; and wherein the first surface layer of the separating film faces the mold;
(c) optionally deep-drawing the separating film;
(d) introducing the curable fiber composite plastic semi-finished product-into the mold, wherein the second surface layer of the separating film faces the curable fiber composite plastic semi-finished product;
(e) optionally closing and/or evacuating the mold; optionally with deep drawing of the separating film;
(f) heating the mold to a temperature at which the curable fiber composite plastic semi-finished product cures; optionally under pressure;
(g) optionally cooling the cured fiber composite plastic component;
(h) optionally removing the cured fiber composite plastic component together with the separating film adhering to it from the mold; and
(i) optionally detaching the separating film from the cured fiber composite plastic component.

12. The method according to claim 11, wherein the fiber composite plastic component comprises a further material selected from the group consisting of balsa wood, engineered foams, non-woven glass, carbon fibers, glass fibers, and any combination thereof.

13. The method according to claim 11, wherein the fiber composite plastic component is intended for a means of transport, preferably for an aircraft, a spacecraft, a train or a motor vehicle, or is intended for a wind turbine, preferably for a rotor blade.

14. The method according to claim 11, wherein the curable fiber composite plastic semi-finished product comprises a curable epoxy resin or a curable polyester resin; preferably a curable epoxy resin.

15. A fiber composite plastic component, to the outer surface of which a separating film according to claim 1, adheres at least in a partial region and can be detached therefrom, wherein the second surface layer of the separating film faces the fiber composite plastic component.

16-125. (canceled)
